(19) United States
(12) Patent Application Publication
(10) Pub. No.: US 2025/0278180 A1
(43) Pub. Date: Sep. 4, 2025

(54) System and Method For Integrating Selectable Inputs With Real-Time Data Pipelines To Execute Actions

(71) Applicant: The Toronto-Dominion Bank, Toronto (CA)

(72) Inventors: Jasdip Singh DHINDSA, Kleinburg (CA); Laszlo TEGLAS, Markham (CA); Anton TANEV, Toronto (CA)

(73) Assignee: The Toronto-Dominion Bank, Toronto (CA)

(21) Appl. No.: 18/592,806

(22) Filed: Mar. 1, 2024

(51) Int. Cl. G06F 3/04842; G06F 3/0483; G06Q 40/04

(52) U.S. Cl. CPC G06F 3/04842; G06F 3/0483; G06Q 40/04

(57) ABSTRACT

A system and method are provided for integrating selectable inputs with real-time data pipelines to execute actions. The method includes obtaining, via the data interface, at least one dataset comprising real-time data used to execute an action; rendering, to a client device coupled to the system, a graphical user interface that presents the real-time data from the at least one dataset; enabling selection of a datapoint on the real-time data from the graphical user interface; displaying information associated with the action based on the selection; enabling the selection to be confirmed as an input to execute the action; providing, via the data interface, the input to a real-time data pipeline; and executing a workflow comprising execution of the action using the input.

### TECHNICAL FIELD

The following generally relates to executing actions from selectable inputs and, more particularly, to integrating such selectable inputs with real-time data pipelines to execute actions.

### BACKGROUND

Graphical user interfaces (GUIs) are used in many systems to obtain selectable inputs, e.g., to execute an action. The GUIs are often tied to underlying computing systems which use the GUIs to present information in order to obtain inputs based on the presented information. However, in many enterprises, GUIs are associated with longstanding legacy systems that fail to incorporate modern features, particularly user-friendly access to information in real-time or navigation between features. In some cases, information presented in a GUI from one application is required to interact with a GUI or other interface in a completely other application, which can be inefficient and time consuming.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of an example configuration for integrating a trade execution platform with data and services associated with an enterprise system.

FIG. 3 is a block diagram illustrating a multi-environment configuration for the trade execution platform.

FIG. 4 is a block diagram illustrating additional implementation details for integrating the trade execution platform in an enterprise system.

FIG. 5 is a block diagram of an example configuration of an enterprise system.

FIG. 6 is a block diagram of an example configuration of a user device.

FIG. 7 is a sequence diagram illustrating user authentication and authorization operations.

FIG. 8 is a sequence diagram illustrating order flow operations.

FIG. 9 is a sequence diagram illustrating trade execution operations.

FIG. 10 is a sequence diagram illustrating data feed integration.

FIG. 11 is a sequence diagram illustrating reconciliation operations.

FIG. 12 is a sequence diagram illustrating transaction posting operations.

FIG. 13 is a GUI illustrating an action execution sequence initiated directly from a set of displayed datapoints.

FIG. 14 is a flowchart illustrating operations for executing an action from a set of displayed datapoints.

FIG. 15 is a GUI illustrating an action execution sequence implemented for a securities trade from a chart.

FIG. 16 is a GUI illustrating an action execution sequence implemented for a securities trade from a chart.

FIG. 17 is a GUI illustrating a heatmap of data obtained via real-time data pipelines.

FIG. 18 is a GUI illustrating a consolidated view of data associated with an entity.

FIG. 19 is a GUI illustrating a calendar of event data pulled from the real-time data pipelines.

### DETAILED DESCRIPTION

To address challenges with obtaining inputs from GUIs in legacy systems, a platform is described which obtains real-time data pipelines and integrates same with GUI selectable inputs to enable selectable features that overcome the time and computing constraints of legacy systems, which experience a disconnect between user interactivity and backend systems and processes.

For example, the proposed solution may combine customizable workspaces with access to a robust backend pipeline of data to permit efficient operations such as trade execution operations in real-time from a single platform while integrating usable features such as calendars and real-time entity information.

In one aspect, there is provided a system for integrating selectable inputs with real-time data pipelines to execute actions. The system includes a processor, a data interface coupled to the processor, and a memory coupled to the processor and data interface. The memory stores computer-executable instructions that, when executed by the processor, cause the system to obtain, via the data interface, at least one dataset comprising real-time data used to execute an action; render, to a client device coupled to the system, a graphical user interface that presents the real-time data from the at least one dataset; enable selection of a datapoint on the real-time data from the graphical user interface; display information associated with the action based on the selection; enable the selection to be confirmed as an input to execute the action; provide, via the data interface, the input to a real-time data pipeline; and execute a workflow comprising execution of the action using the input.

In certain example embodiments, the real-time data pipeline and workflow correspond to a regulated environment coupled to the system.

In certain example embodiments, the real-time data pipeline and workflow correspond to a simulation of a regulated environment coupled to the system.

In certain example embodiments, the computer-executable instructions, when executed by the processor, further cause the system to: enable the input to be converted to execution in the regulated environment.

In certain example embodiments, converting the input includes updating execution of the action based on updated real-time data.

In certain example embodiments, the datapoint is selectable using a line spanning a dimension of the graphical user interface, the line being moveable over a graphical representation of the real-time data to provide one or more intersections with the real-time data to identify one or more corresponding selectable datapoints.

In certain example embodiments, the computer-executable instructions, when executed by the processor, further cause the system to: provide, via the graphical user interface, a calendar page of event data pulled from the real-time data, the event data being selectable to provide additional information for an associated event; and enable, via the graphical user interface, navigation between the calendar page and a chart page displaying the real-time data from the at least one data set.

In certain example embodiments, the system obtains a plurality of datasets from a plurality of third party sources by integrating the plurality of datasets into a feed provided to the data pipeline on a regular basis.

In certain example embodiments, the real-time data includes pricing data for securities, the action comprising execution of a securities transaction.

In certain example embodiments, the system is integrated as a platform into an enterprise system.

In certain example embodiments, the client device is associated with an external client or an internal client authenticated to the platform.

In another aspect, there is provided a method of integrating selectable inputs with real-time data pipelines to execute actions. The method may be executed by a processor of a computer system comprising a data interface. The method includes obtaining, via the data interface, at least one dataset comprising real-time data used to execute an action; rendering, to a client device coupled to the system, a graphical user interface that presents the real-time data from the at least one dataset; enabling selection of a datapoint on the real-time data from the graphical user interface; displaying information associated with the action based on the selection; enabling the selection to be confirmed as an input to execute the action; providing, via the data interface, the input to a real-time data pipeline; and executing a workflow comprising execution of the action using the input.

In certain example embodiments, the real-time data pipeline and workflow correspond to a regulated environment coupled to the system.

In certain example embodiments, the real-time data pipeline and workflow correspond to a simulation of a regulated environment coupled to the system.

In certain example embodiments, the method further includes enabling the input to be converted to execution in the regulated environment.

In certain example embodiments, converting the input may include updating execution of the action based on updated real-time data.

In certain example embodiments, the datapoint is selectable using a line spanning a dimension of the graphical user interface, the line being moveable over a graphical representation of the real-time data to provide one or more intersections with the real-time data to identify one or more corresponding selectable datapoints.

In certain example embodiments, the method may further include providing, via the graphical user interface, a calendar page of event data pulled from the real-time data, the event data being selectable to provide additional information for an associated event; and enabling, via the graphical user interface, navigation between the calendar page and a chart page displaying the real-time data from the at least one data set.

In certain example embodiments, the system obtains a plurality of datasets from a plurality of third party sources by integrating the plurality of datasets into a feed provided to the data pipeline on a regular basis.

In another aspect, there is provided a computer readable medium comprising computer-executable instructions for integrating selectable inputs with real-time data pipelines to execute actions. The computer readable medium is executed by a processor of a computer system comprising a data interface, and includes instructions for: obtaining, via the data interface, at least one dataset comprising real-time data used to execute an action; rendering, to a client device coupled to the system, a graphical user interface that presents the real-time data from the at least one dataset; enabling selection of a datapoint on the real-time data from the graphical user interface; displaying information associated with the action based on the selection; enabling the selection to be confirmed as an input to execute the action; providing, via the data interface, the input to a real-time data pipeline; and executing a workflow comprising execution of the action using the input.

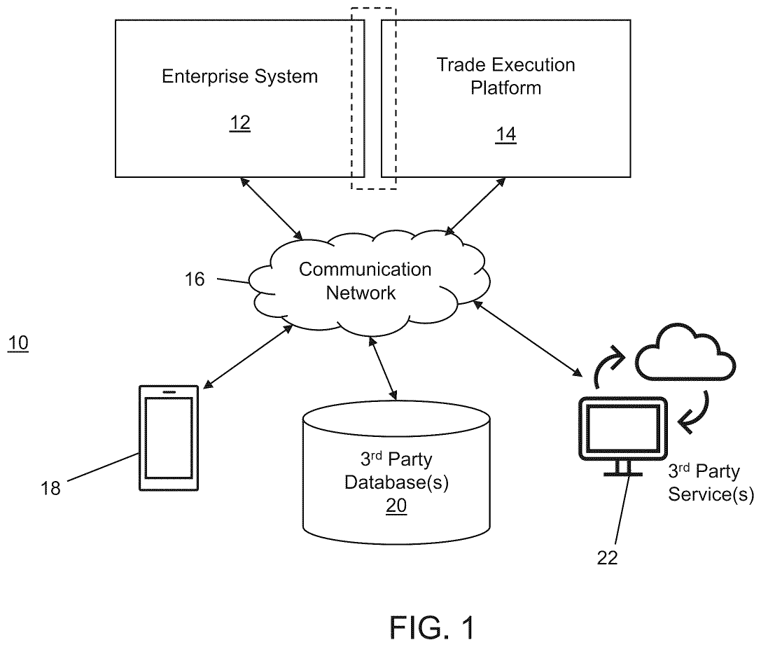

Referring now to the figures, FIG. 1 illustrates an exemplary computing environment 10 in which the elements of the disclosed system(s) may operate. The computing environment 10 can include one or more user devices 18, a communications network 16 connecting one or more components of the computing environment 10, for example an enterprise system 12, a trade execution platform 14, one or more 3^{rd} party databases 20, and one or more 3^{rd} party services 22. As illustrated using a dashed box in FIG. 1, the enterprise system 12 and the trade execution platform 14 may be coupled directly or indirectly to each other, e.g., via internal or external network or other computing interfaces. That is, it can be appreciated that the trade execution platform 14 may be a component or portion of the enterprise system 12 or may be a separate platform 14 coupled thereto.

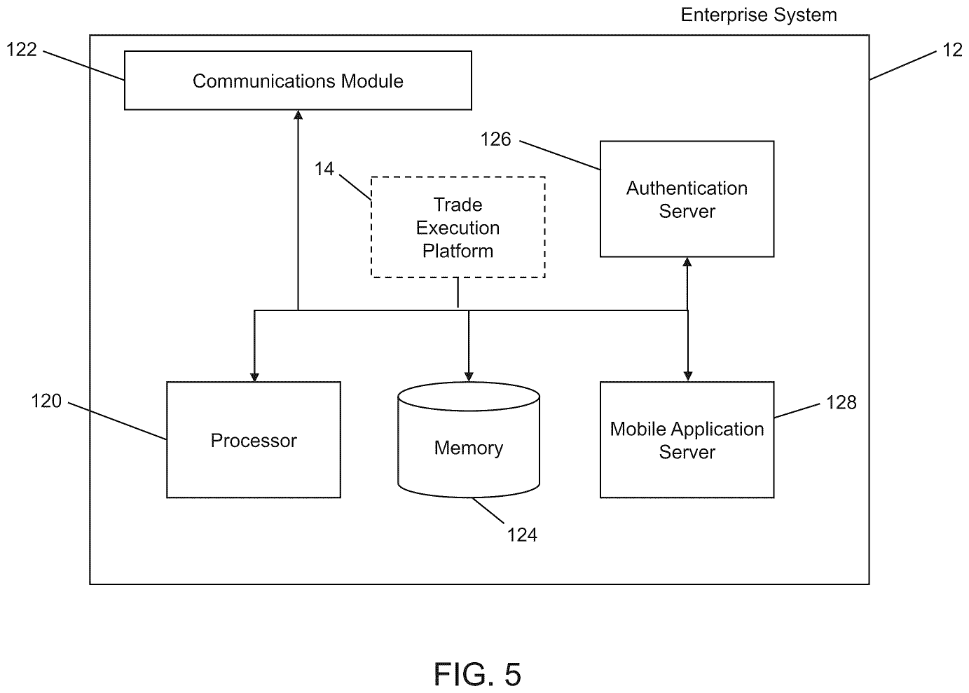

The enterprise system 12 (e.g., a financial institution such as commercial bank and/or lender) can be a system that provides a plurality of services via a plurality of enterprise resources (e.g., database resources, computing resources, both internally to enterprise users and externally to enterprise clients). The enterprise services can be provided by dedicated computing resources (e.g., via dedicated hardware), or through resources shared amongst the enterprise system 12. The enterprise resources can be provided by the enterprise system 12, or by a third party contracted by the enterprise system 12 (e.g., a cloud computing provider), etc. In an example embodiment, the enterprise system 12 is a system that includes sensitive computing resources, such as records of financial services or user accounts or transactions associated with those financial service accounts. While several details of the enterprise system 12 have been omitted for clarity of illustration, reference will be made to FIG. 5 below for additional details. As indicated above, the trade execution platform 14 can be hosted and provided within the enterprise system 12 as illustrated in FIG. 5.

User devices 18 may be associated with one or more users which can have authenticated access to the enterprise resources or other parts of the enterprise system 12. Users may be customers, employees, contractors, regulators, or other entities that interact with the enterprise system 12 and/or trade execution platform 14 (directly or indirectly). The computing environment 10 may include multiple user devices 18, each user device 18 being associated with a separate user or associated with one or more users. The client devices can be external to the enterprise system 12 (e.g., as shown in FIG. 1) or internal to the enterprise system 12. In certain embodiments, a user may operate user device 18 such that user device 18 performs one or more processes consistent with the disclosed embodiments. For example, the user may employ user device 18 to interact with a GUI to initiate and complete executable actions via the trade execution platform 14.

User devices 18 can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 16.

Communication network 16 may include a telephone network, cellular, and/or data communication network to connect different types of user devices 18 and systems (e.g., enterprise system 12 and trade execution platform 14 which may utilize server computing devices). For example, the communication network 16 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

The trade execution platform 14 and/or enterprise system 12 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications of the trade execution platform 14 and enterprise system 12. The cryptographic server may, for example, be used to protect the financial data and/or client data and/or transaction data within the enterprise system 12 by way of encryption for data protection, digital signatures or message digests for data integrity, and by using digital certificates to authenticate the identity of the users and user devices 18 with which the enterprise system 12 and/or trade execution platform 14 communicates to inhibit misuse. It can be appreciated that various cryptographic mechanisms and protocols can be chosen and implemented to suit the constraints and requirements of the particular deployment of the trade execution platform 14 or enterprise system 12 as is known in the art.

Also shown in FIG. 1 are the one or more 3rd party databases 20 and the one or more 3^{rd} party services 22. The databases 20 and services 22 may be associated with each other or may be separate and represent any source of data and information that may be obtained or provided to the trade execution platform 14 and enterprise system 12. For example, the trade execution platform 14, as discussed further below, may include one or more data pipelines from which to feed interfaces to enable actions to be executed in real-time or near real-time without requiring navigation between multiple programs or unnecessary delays or interruptions.

The 3^{rd} party database(s) 20 may provide entity (e.g., company) information, market or other information for an environment (e.g., securities trading, etc.). The 3^{rd} party service(s) 22 may provide data and information according to the terms of a service, which may be publicly available or require a subscription. The trade execution platform 14 is configured to obtain and integrate multiple and disparate sources of data and information to provide one or more feeds thereinto.

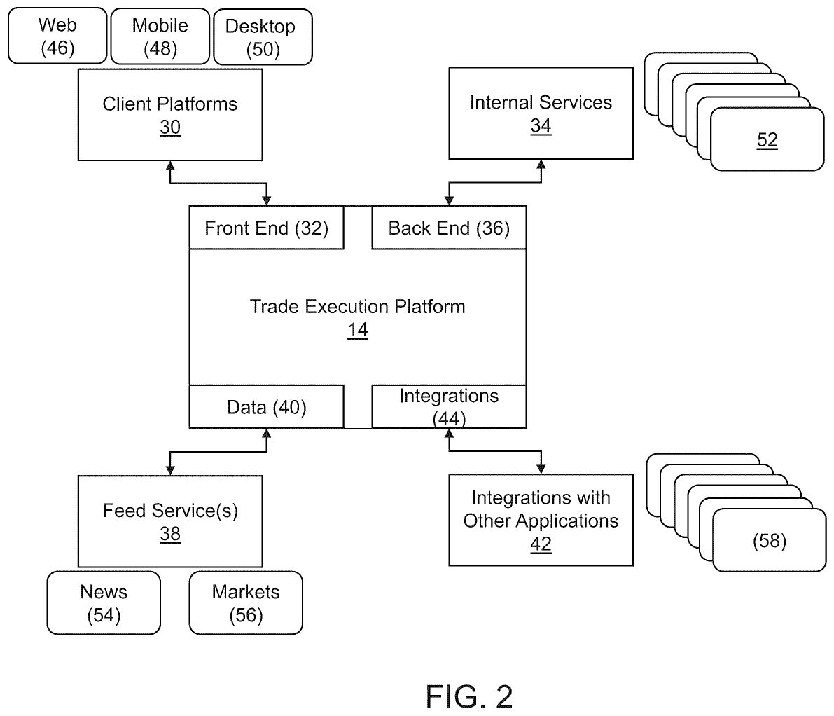

FIG. 2 illustrates an example of a configuration for integrating the trade execution platform 14 with data and services associated with the enterprise system 12. In order to enable real-time actions to be executed using the trade execution platform 14, various data sources and services are to be integrated and made available thereto. In this example configuration, users may interact with the system via one or more client platforms 30. The client platforms 30 are interfaced via a front end interface 32. In this example, the client platforms 30 include web 46 (e.g., via an Internet browser), mobile 48 (e.g., via a mobile app), and desktop 50 (e.g., via an installed desktop computer application).

Various internal services 34 are coupled to the trade execution platform 14 via a back end interface 36. The internal services 34 may connect to individual service entities at a back end 52 such as a backend for frontends (BFF), an adapter enumeration application programming interface (API) such as dxCore™, various supporting services, and/or various database management systems such as Postgres™.

The trade execution platform 14 obtains various data and information from one or more feed services 38 via a data interface 40. This may include, for example, news feed(s) 54 and market feed(s) 56. The trade execution platform 14 also integrates with other applications via one or more integrations 42 and an integrations interface 44. The integrations 42 provide access to applications 58, which may include, among others, various enterprise applications, and various external applications used by other users such as brokers.

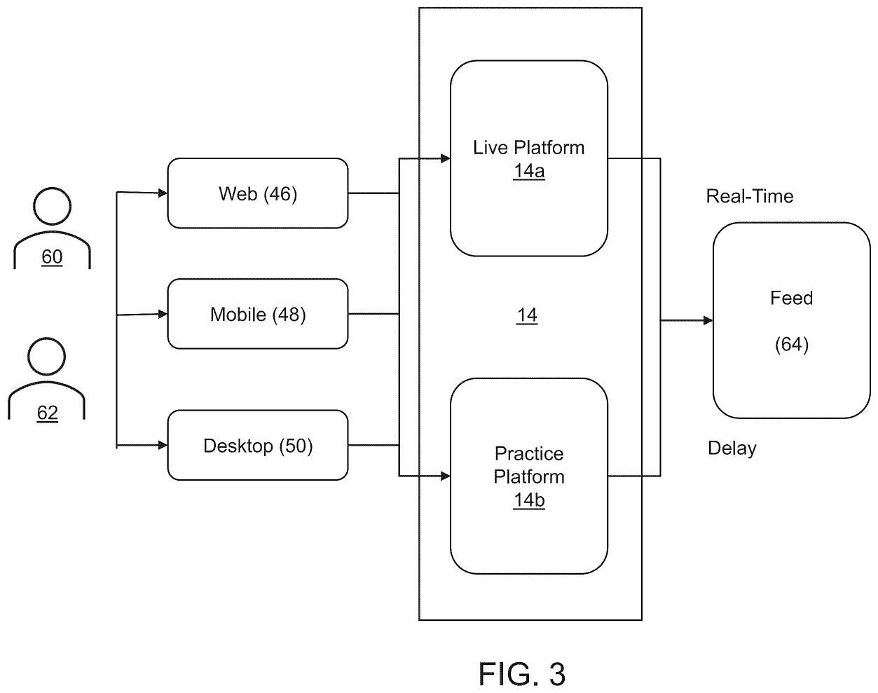

Referring now to FIG. 3, the trade execution platform 14 may be configured to utilize the various data pipelines that obtain real-time data to enable users to perform both live actions such as execute live trades as well as to perform simulated or “practice” operations such as practice trades to evaluate strategies, outcomes and for training purposes. That is, the trade execution platform 14 can leverage the real-time data pipelines to operate both within regulated and simulated environments. This allows the GUIs described in greater detail below, to be integrated into both such environments. In the configuration shown in FIG. 3, the web 46, mobile 48 and desktop 50 client platforms 30 may be used by authorized/authenticated/existing/regular users 60 or by prospective users 62. For example, the prospective users 62 may include prospective customers that wish to simulate a trade to determine their comfort level with interacting with the trade execution platform 14 personally and directly rather than through a broker or other service provider. The trade execution platform 14 may therefore include multiple sub-platforms, in this case a live platform 14a and a practice platform 14b. Each type of user 60, 62 may access via a web 46, mobile 48 or desktop 50 utility such as corresponding application zone or login to enable either live or practice/simulated operations. The inputs obtained via these platforms 14a, 14b may then either operate using live, real-time data or delayed data to permit the associated temporality of the action.

It can be appreciated that the trade execution platform 14 may be configured to enable navigation and “conversion” of actions between the live platform 14a and practice platform 14b. In this way, actions simulated in the practice platform 14b may be converted to a real-time action such as a requested trade, by normalizing, updating and/or refreshing the parameters, e.g., using fresh or updated data. That is, an action executed in the practice platform 14b may at least in part be leveraged to minimize the number of steps needed to execute the same action live and in real-time. Any regulatory or other constraints may also be enforced on such a conversion to enable the simulated actions to be executed in real-time within a regulated environment in a way that is compliant.

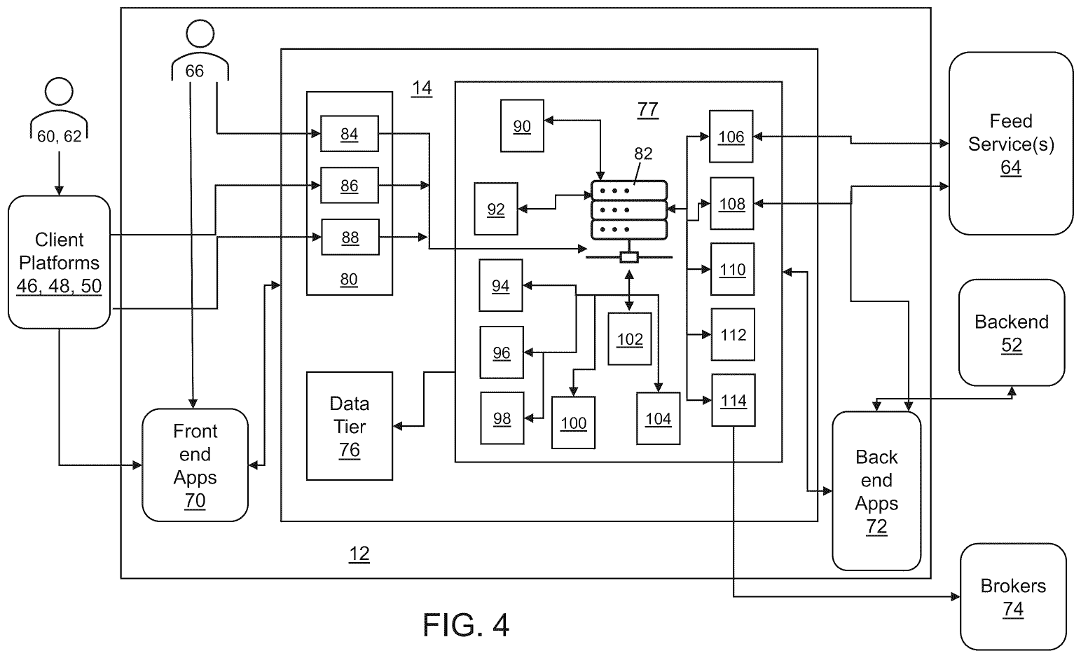

FIG. 4 illustrates further detail of an example configuration for integrating the trade execution platform 14 into an enterprise system 12 such as a financial institution that provides access to such a platform 14. In this example configuration, the trade execution platform 14 is hosted within or by the enterprise system 12 by being positioned between front end enterprise apps 70 and back end enterprise apps 72. The front end apps 70 may be accessed from external users 60, 62 via the client platforms 46, 48, 50 as shown, or by internal users 66 such as employees, administrators, etc. The client platforms 46, 48, 50 may also be coupled to a web tier 80 of the trade execution platform 14.

The web tier 80 is coupled to a main server 82 and provides a web admin 84, a web BFF 86, and a mobile BFF 88. The main server 82 is hosted within an app tier 77 and is coupled to a data tier 76 and the back end enterprise apps 72. The main server 82 provides, among other things, an adapter enumeration API, a business rules engine, and may provide multiplexing functionality. Numerous modules are shown in the app tier 77 in FIG. 4, which are shown by way of example, without limitation. In this example, the app tier 77 may include an alert engine 90, a risk reporter 92 (e.g., for option expiries), an account risk monitor 94, order activators 96, and utilities 98. The app tier 77 may also include a loan post router 100, order routing tracker 102, and an analyst report gate 104 used internally within the app tier 77.

The app tier 77 may also include a number of functions that interface with external functions and services, either within the enterprise system 12 or to 3^{rd} parties. For example, the app tier 77 may house a market data service 106, which interfaces with a feed service 64. A batch jobs function 108 may also interface with the feed service(s) 64 to execute multiple batch jobs to obtain data and information. An event fabric gateway 110 may be used to access event data within, for example, the enterprise system 12, and a trade reporter 112 may be used to obtain trade reports, either from the enterprise system 12 or externally (or both). One or more routers 114 may be used to interface with external brokers 74. Also shown in FIG. 4, a back end 52 may be interfaced with the app tier 77 via the back end apps 72. The back end apps 72 may also obtain information via the feed service(s) 64.

In FIG. 5, an example configuration for an enterprise system 12 is shown. In certain embodiments, the enterprise system 12 may include one or more processors 120, a communications module 122, and a database interface module (not shown) for interfacing with remote or local datastores to retrieve, modify, and store (e.g., add) data and information and/or data resources. Communications module 122 enables the enterprise system 12 to communicate with one or more other components of the computing environment 10, such as a user device 18 (or one of its components), via a bus or other communication network, such as the communication network 16. The enterprise system 12 can include at least one memory or memory device 124 that can include a tangible and non-transitory computer-readable medium having stored therein computer programs, sets of instructions, code, or data to be executed by processor 120.

FIG. 5 illustrates examples of modules, tools and engines stored in memory on the enterprise system 12 and operated or executed by the processor 120. It can be appreciated that any of the modules, tools, and engines shown in FIG. 5 may also be hosted externally and be available to the enterprise system 12, e.g., via the communications module 122. In the example embodiment shown in FIG. 5, the enterprise system 12 includes an authentication server 126, for authenticating users to access resources of the enterprise, and mobile application server 128 to facilitate a mobile application that can be deployed on mobile user devices 18. The enterprise system 12 can include an access control module (not shown) and/or cryptographic server(s) as noted above.

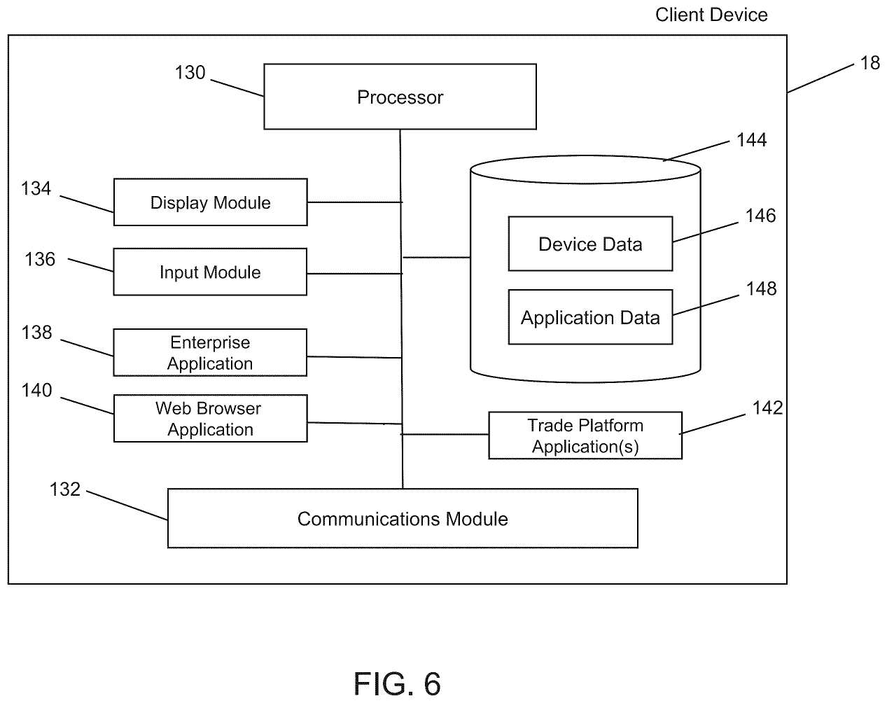

In FIG. 6, an example configuration of a user device 18 is shown. In certain embodiments, the user device 18 may include one or more processors 130, a communications module 132, and a data store 144 storing device data 146 and application data 148. Communications module 132 enables the user device 18 to communicate with one or more other components of the computing environment 10, such as enterprise system 12, via a bus or other communication network, such as the communication network 16. While not delineated in FIG. 6, the user device 18 includes at least one memory or memory device that can include a tangible and non-transitory computer-readable medium having stored therein computer programs, sets of instructions, code, or data to be executed by processor 130. FIG. 6 Illustrates examples of modules and applications stored in memory on the user device 18 and operated by the processor 130. It can be appreciated that any of the modules and applications shown in FIG. 6 may also be hosted externally and be available to the user device 18, e.g., via the communications module 132.

In the example embodiment shown in FIG. 6, the user device 18 includes a display module 134 for rendering GUIs and other visual outputs on a display device such as a display screen, and an input module 136 for processing user or other inputs received at the user device 18, e.g., via a touchscreen, input button, transceiver, microphone, keyboard, etc. The user device 18 may also include an enterprise application 138 provided by the enterprise system 12, e.g., for submitting requests to perform mobile banking, investing, or other performing financial services. The user device 18 in this example embodiment also includes a web browser application 140 for accessing Internet-based content, e.g., via a mobile or traditional website and one or applications (not shown) offered by the enterprise system 12 or the trade execution platform 14. The data store 144 may be used to store device data 146, such as, but not limited to, an IP address or a MAC address that uniquely identifies user device 18 within environment 10. The data store 144 may also be used to store authentication data, such as, but not limited to, login credentials, user preferences, cryptographic data (e.g., cryptographic keys), etc.

It will be appreciated that only certain modules, applications, tools, and engines are shown in FIGS. 2 to 6 for ease of illustration and various other components would be provided and utilized by the trade execution platform 14, enterprise system 12, and user device 18, as is known in the art.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any component of or related thereto, etc., or accessible or connectable thereto (e.g., enterprise system 12, trade execution platform 14, user device 18, etc.). Any application or module herein described may be implemented using computer readable/executable instructions that may be stored or otherwise held by such computer readable media.

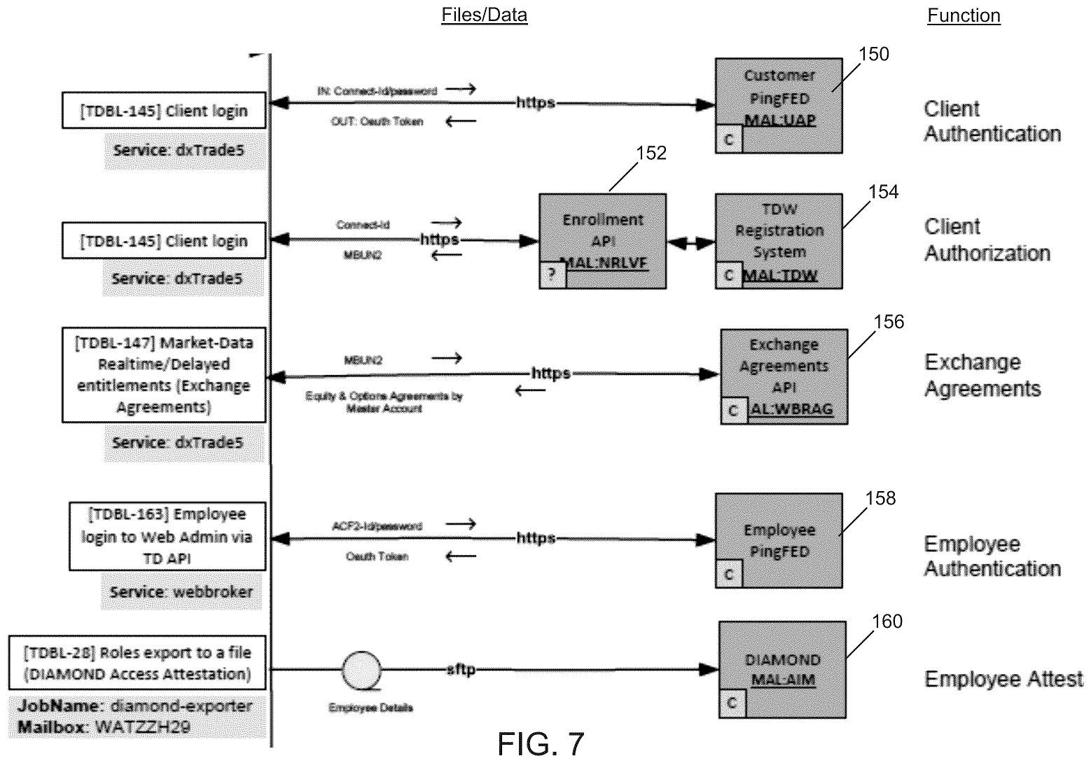

Referring now to FIGS. 7 to 12, certain data flows and communication exchanges are shown that illustrate integration of the trade execution platform 14 with the enterprise system 12 and various third party entities, including users 60, 62, 66, to obtain real-time data that is then further leveraged and integrated with internal systems and GUIs.

FIG. 7 illustrates certain authentication and authorization flows. Here, a client login may be used to perform a client authentication over https using an identity management module 150, and client authorization, which in this example uses an enrollment API 152 and a registration system 154. After authentication and authorization, the client may exchange agreements via an agreements API 156. A separate employee authentication may be performed using an employee identity module 158 and then the employee may perform attestation using an attestation module 160.

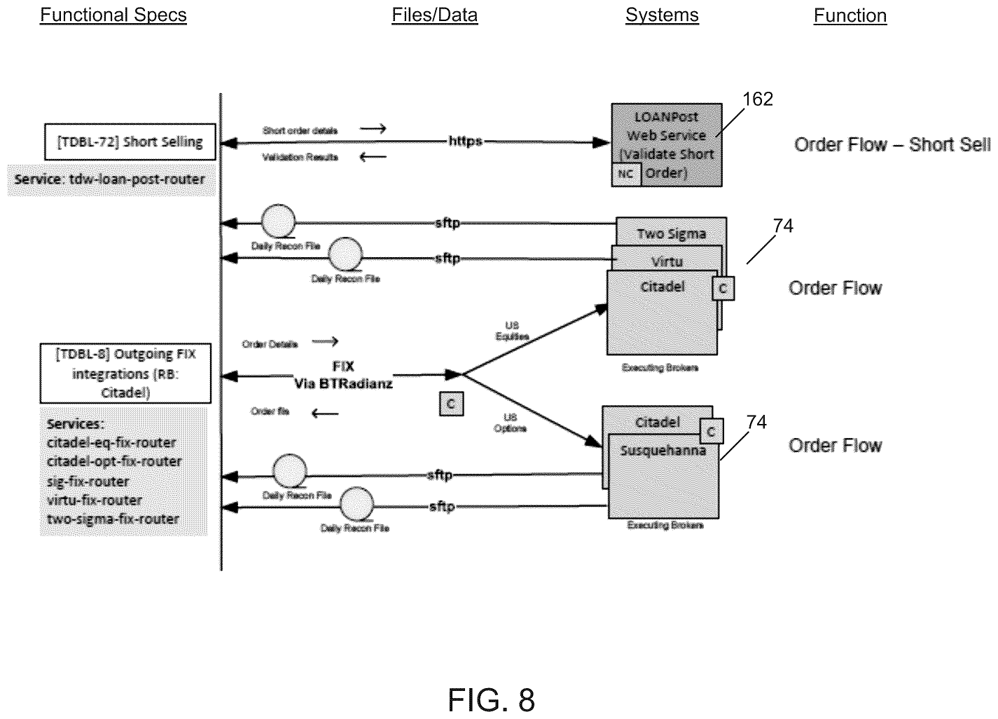

As shown in FIG. 8, various order flows may be executed over https or sftp exchanges. Here, a short sell may be initiated directly via a short selling web service 162. The brokers 74 may communicate via outgoing integrations where data is routed to the brokers 74 in order to execute an order.

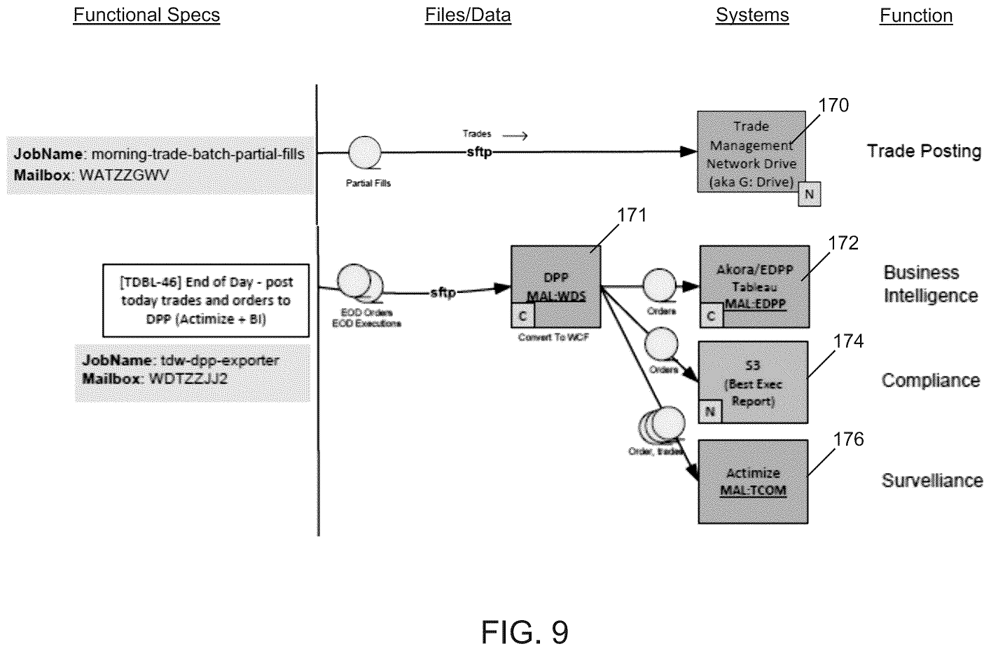

Referring now to FIG. 9, a morning trade batch can send trades over sftp to a trade management network drive 170 to post trades. At the end of the day, trades during the day and posted orders can be communicated via a conversion module 171. This provides orders to a business intelligence module 172, orders to a compliance module 174 to ensure compliance, and orders and trades to a surveillance module 176 to track activities within the trade execution platform 14.

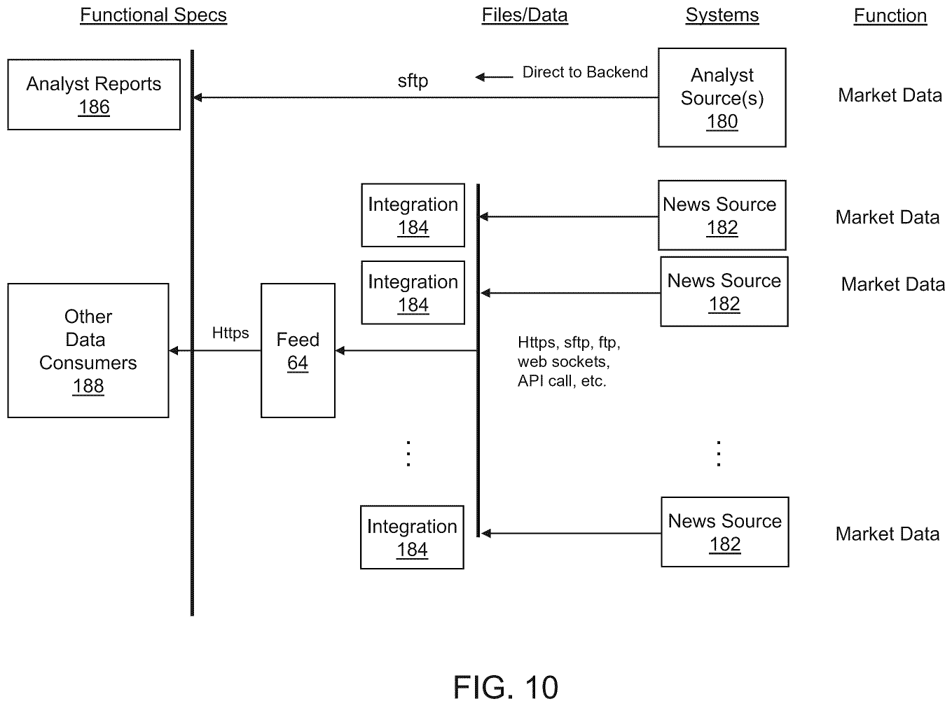

FIG. 10 illustrates a market data feed workflow that may be used to integrate disparate sources of data and information into the feed service(s) 64 for various data consumers within the trade execution platform 14 and the enterprise system 12. As shown, one or more analyst sources 180 may provide data directly to the back end, e.g., via sftp, to generate analyst reports 186. New sources 182, on the other hand, may feed into an internal data pipeline that hosts a number of integration modules 184 used to integrate, convert, normalize or otherwise process or pre-process the market data to be able to provide a consistent feed service 64. This feed service 64 may then be provided to data consumers 188 within the computing environment 10, e.g., over https.

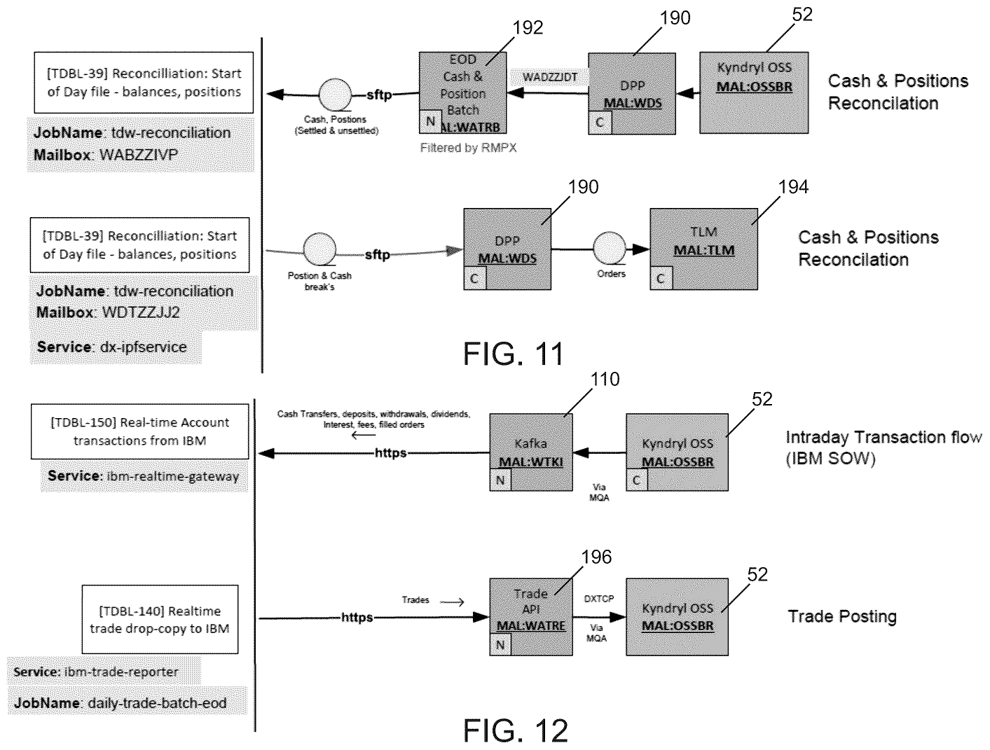

FIG. 11 illustrates data flows for performing reconciliations. The back end 52 provides the cash and positions to a cash and positions batch module 192 via an intermediate module 190. This enables the platform 14 to have the start of day file, including balances and positions. The platform 14 also provides the position and cost to the intermediate module 190, which is stored for external use via interface module 194.

Referring to FIG. 12, an intraday transaction flow provides the event gateway 110 with back end day via the back end 52. This enables the platform 14 to determine real-time account transactions. Trade posting works in the opposite direction wherein the platform 14 provides real-time trade data to a trade API 196, which then sends to the back end 52 to have the trades posted within the regulated environment such as a stock market exchange and the like.

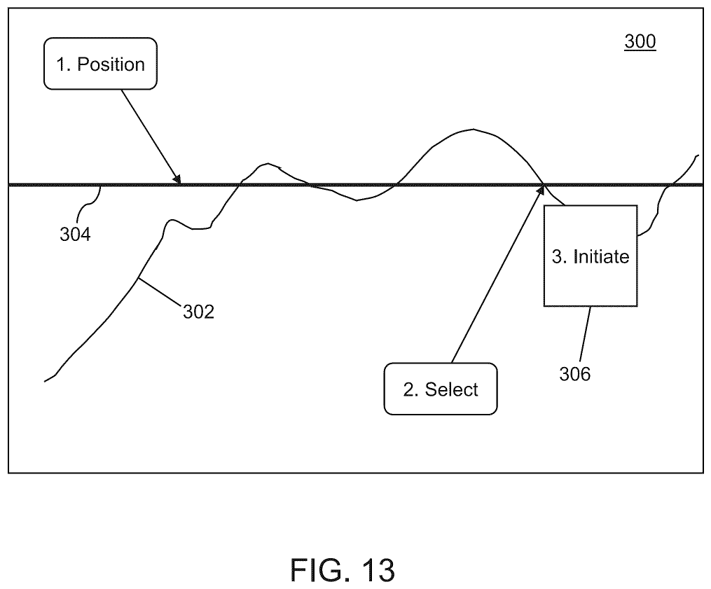

The various trading flows described herein may be leveraged and integrated with various GUI functionality to permit easier and more efficient and intuitive actions to be executed, such as initiating a trade. For example, a GUI 300 may be provided, as shown in FIG. 13, to permit an action to be executed based on selection of a datapoint on a chart directly from within the GUI 300. By integrating the market data as shown in FIG. 10, the GUI 300 can present consistent and real-time data from a single feed service 64 or feed source to enable functionality to be triggered from directly within the GUI 300.

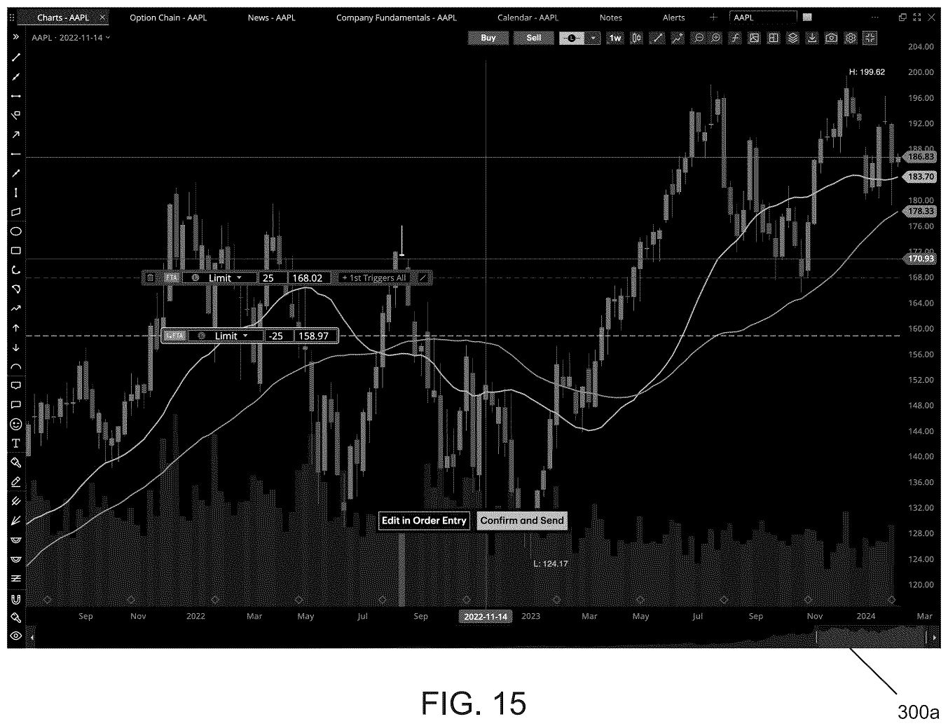

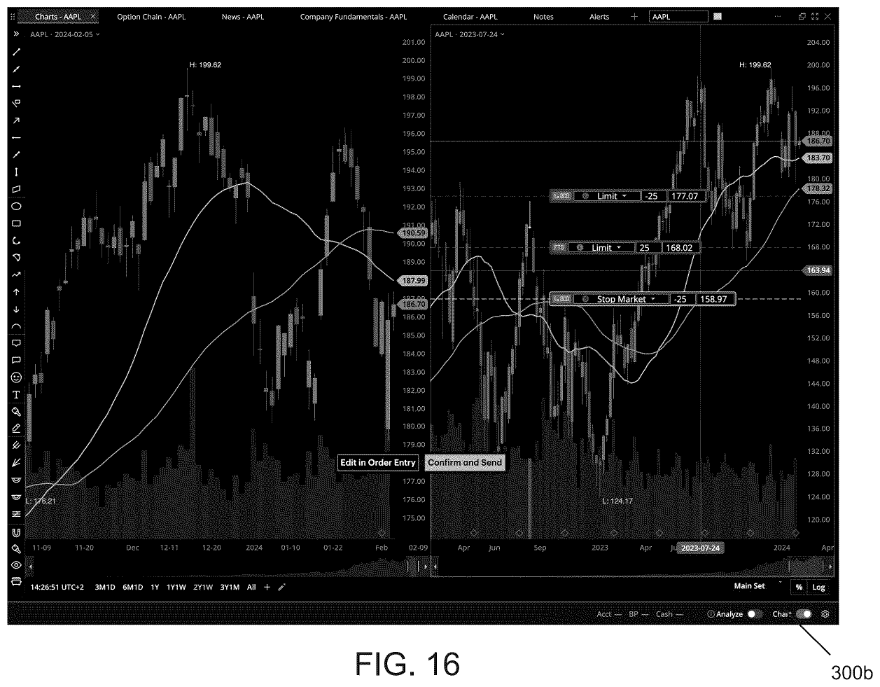

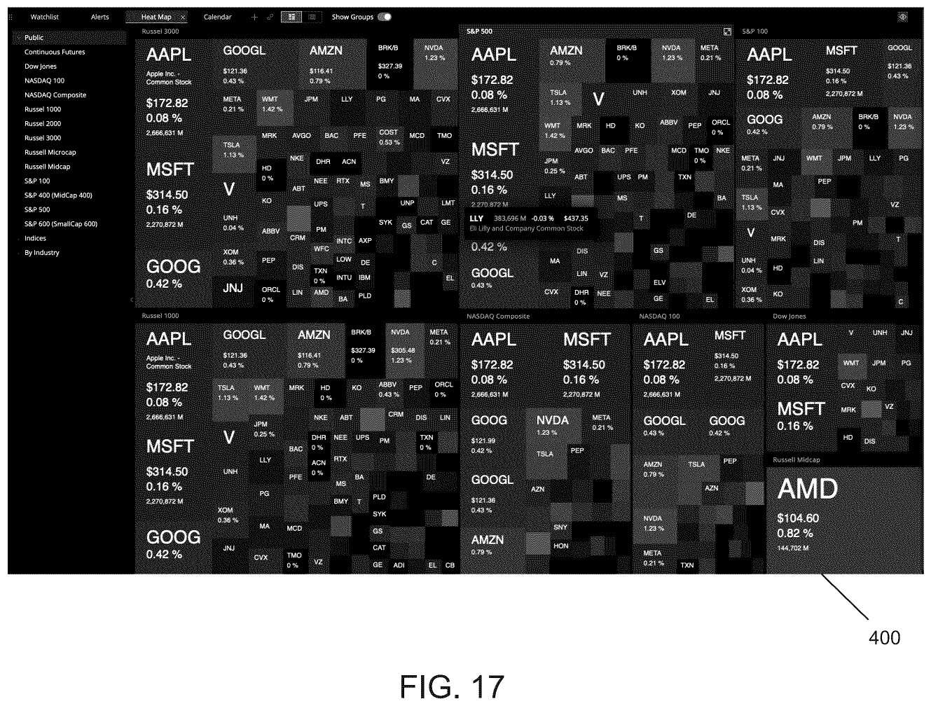

For example, as shown in FIG. 13, a generally horizontal line 304 or other marker may be provided to allow a user to position the marker (e.g., line 304) at step 1 such that it may intersect a charted data set 302. The data set 302 includes a number of data points, one of which may be selected at step 2. For example, if the user wishes to initiate an order to buy shares at the price indicated at that point in the chart, the selection of the data point at step 2 may initiate on option 306 (or menu of options 306) to initiate an order at that price. It can be appreciated that other actions may be executed by interacting with data points charted in a GUI 300, such as editing, parameter adjustment, quantities, etc. By integrating the GUI 300 with the real-time data pipelines shown in FIGS. 2-4, the GUI 300 can more conveniently be used to enable actions to be executed by familiar and intuitive interactions. For example, as shown in FIGS. 15 and 16, familiar charting of real-time data can be viewed and data points selected to enable a trade to be initiated directly from the charts shown in the GUIs 300a, 300b.

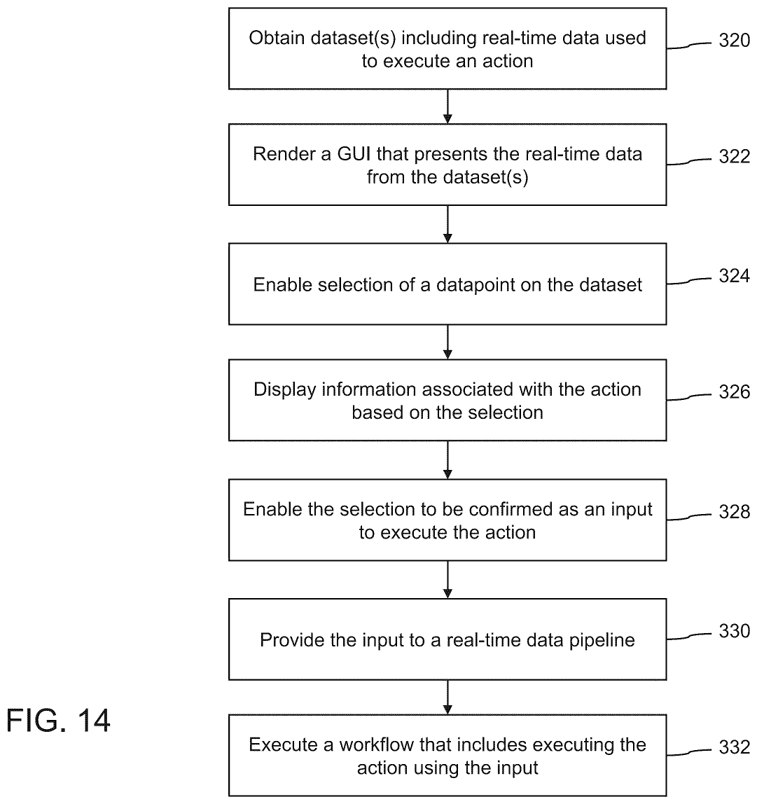

Referring now to FIG. 14, a flow chart is provided illustrating operations that may be performed in executing an action from a GUI, e.g., GUI 300 shown in FIG. 13. At block 320, the GUI 300 uses its integration with the data pipeline(s) of the trade execution platform 14 to obtain one or more datasets that include real-time data, e.g., market data, that is used to execute an action (e.g., a trade).

At block 320, the GUI 300 is rendered in which the dataset is presented, e.g., by charting a stock price in the GUI 300 as shown in FIGS. 15 and 16. At block 322, the GUI 300 enables selection of a datapoint on the dataset, e.g., as shown in FIG. 13. Based on this selection, at block 324, information associated with the action is displayed, e.g., an option to initiate a trade, additional information, etc. At block 328, the selection may be confirmed as an input to execute the action (e.g., request a trade at the price associated with the datapoint).

At block 330, the input is provided to the real-time data pipeline, which is integrated with the GUI 300 to permit real-time actions. At block 332, a workflow (or workflows) such as a trade validation, buying power calculation, etc., may be executed, which would include execution of the action that is associated with the input that was captured via the GUI 300.

In this way, detailed and accurate data such as that charted in FIGS. 15 and 16 may be both presented and provided as a portal or conduit into the underlying data pipeline of the trade execution platform 14 to enable real-time operations to be conveniently executed.

Additional GUIs may also be presented using the data and information of the data pipelines shown in FIGS. 2-4. For example, a heatmap GUI 400 may be displayed as shown in FIG. 17 that can leverage the various data feeds integrated and made consistent by the data feed service(s) 64 to provide visual indications of data that may also be selected to initiate an action. For example, an entity with a corresponding stock may be selected from GUI 400 to access further information, initiate a trade, etc. The heatmap in GUI 400 can provide relative information about market capitalization, price, etc.

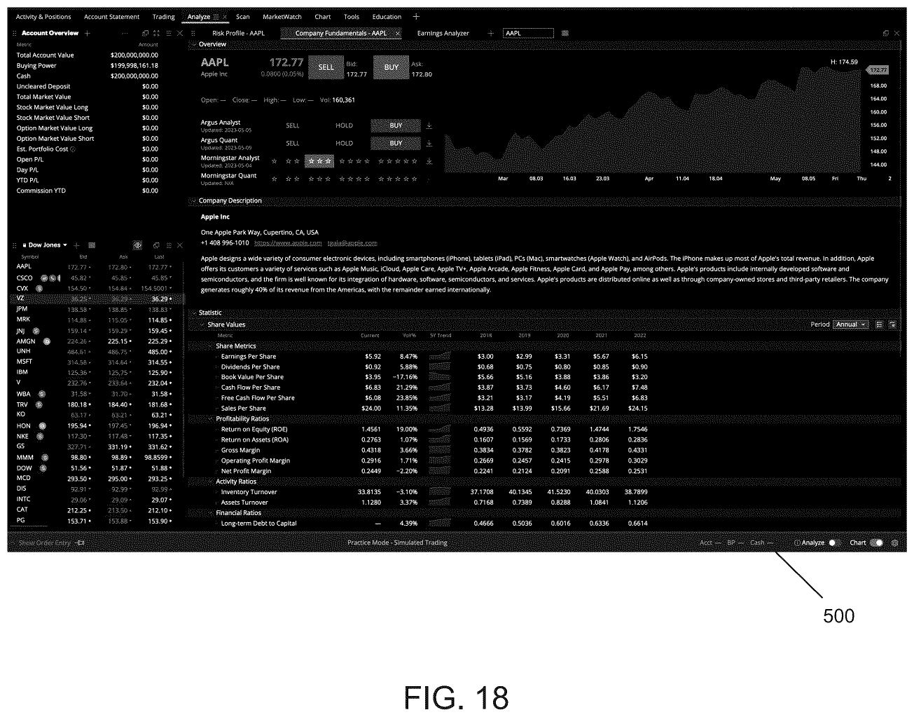

FIG. 18 illustrates another GUI 500 that may be provided by the trade execution platform 14 to permit the data pipelines to be leverages to show all available information for an entity, including statistics, analyst reports, etc. From this GUI 500, a user may be able to select a chart to navigate to GUI 300, e.g., to then initiate a trade. The data pipelines may therefore be leveraged to provide as much real-time data and information as available to facilitate usability of the trade execution platform 14.

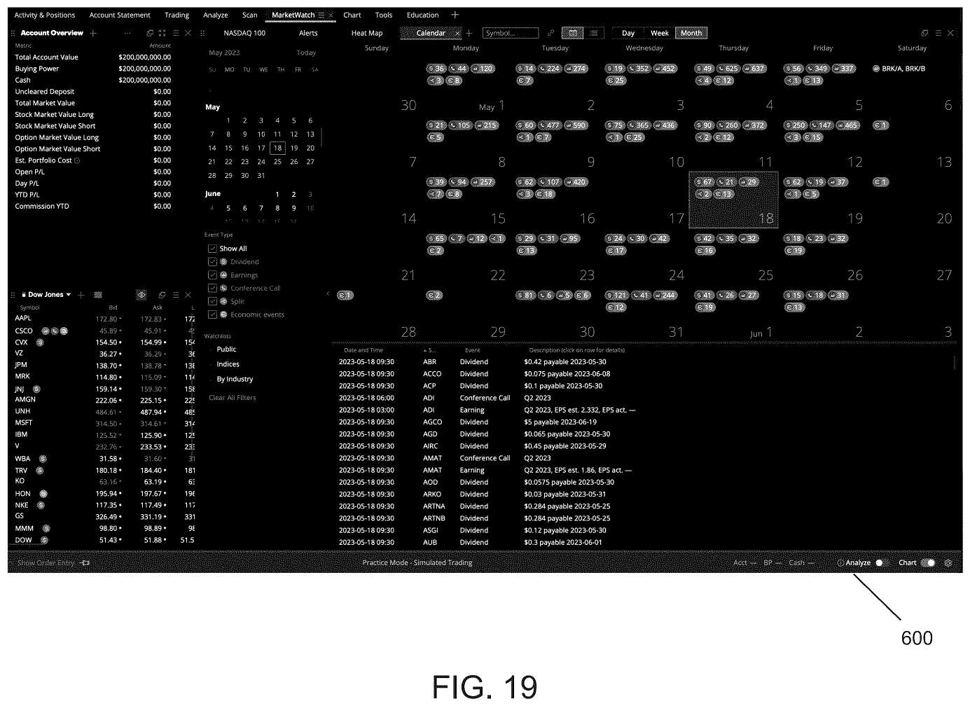

Another GUI 600 is shown in FIG. 19, which provides a calendar-like presentation of event data obtained from the data pipelines. For example, the calendar may be populated with earnings reports days, meetings, conference calls and other events associated with the data sets that the user can interact with. The calendar view in GUI 600 may also enable selection of individual events to reveal additional information and enable navigation to other GUIs such as those shown in FIGS. 15-18.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A system for integrating selectable inputs with real-time data pipelines to execute actions, the system comprising:
a processor;
a data interface coupled to the processor; and
a memory coupled to the processor and data interface, the memory storing computer-executable instructions that, when executed by the processor, cause the system to:
obtain, via the data interface, at least one dataset comprising real-time data used to execute an action;
render, to a client device coupled to the system, a graphical user interface that presents the real-time data from the at least one dataset;
enable selection of a datapoint on the real-time data from the graphical user interface;
display information associated with the action based on the selection;
enable the selection to be confirmed as an input to execute the action;
provide, via the data interface, the input to a real-time data pipeline; and
execute a workflow comprising execution of the action using the input.

2. The system of claim 1, wherein the real-time data pipeline and workflow correspond to a regulated environment coupled to the system.

3. The system of claim 1, wherein the real-time data pipeline and workflow correspond to a simulation of a regulated environment coupled to the system.

4. The system of claim 3, wherein the computer-executable instructions, when executed by the processor, further cause the system to:
enable the input to be converted to execution in the regulated environment.

5. The system of claim 4, wherein converting the input comprises updating execution of the action based on updated real-time data.

6. The system of claim 1, wherein the datapoint is selectable using a line spanning a dimension of the graphical user interface, the line being moveable over a graphical representation of the real-time data to provide one or more intersections with the real-time data to identify one or more corresponding selectable datapoints.

7. The system of claim 1, wherein the computer-executable instructions, when executed by the processor, further cause the system to:
provide, via the graphical user interface, a calendar page of event data pulled from the real-time data, the event data being selectable to provide additional information for an associated event; and
enable, via the graphical user interface, navigation between the calendar page and a chart page displaying the real-time data from the at least one data set.

8. The system of claim 1, wherein the system obtains a plurality of datasets from a plurality of third party sources by integrating the plurality of datasets into a feed provided to the data pipeline on a regular basis.

9. The system of claim 1, wherein the real-time data comprises pricing data for securities, the action comprising execution of a securities transaction.

10. The system of claim 1, wherein the system is integrated as a platform into an enterprise system.

11. The system of claim 10, wherein the client device is associated with an external client or an internal client authenticated to the platform.

12. A method of integrating selectable inputs with real-time data pipelines to execute actions, the method being executed by a processor of a computer system comprising a data interface, the method comprising:
obtaining, via the data interface, at least one dataset comprising real-time data used to execute an action;
rendering, to a client device coupled to the system, a graphical user interface that presents the real-time data from the at least one dataset;
enabling selection of a datapoint on the real-time data from the graphical user interface;
displaying information associated with the action based on the selection;
enabling the selection to be confirmed as an input to execute the action;
providing, via the data interface, the input to a real-time data pipeline; and
executing a workflow comprising execution of the action using the input.

13. The method of claim 12, wherein the real-time data pipeline and workflow correspond to a regulated environment coupled to the system.

14. The method of claim 12, wherein the real-time data pipeline and workflow correspond to a simulation of a regulated environment coupled to the system.

15. The method of claim 14, further comprising:
enabling the input to be converted to execution in the regulated environment.

16. The method of claim 15, wherein converting the input comprises updating execution of the action based on updated real-time data.

17. The method of claim 12, wherein the datapoint is selectable using a line spanning a dimension of the graphical user interface, the line being moveable over a graphical representation of the real-time data to provide one or more intersections with the real-time data to identify one or more corresponding selectable datapoints.

18. The method of claim 12, further comprising:
providing, via the graphical user interface, a calendar page of event data pulled from the real-time data, the event data being selectable to provide additional information for an associated event; and
enabling, via the graphical user interface, navigation between the calendar page and a chart page displaying the real-time data from the at least one data set.

19. The method of claim 12, wherein the system obtains a plurality of datasets from a plurality of third party sources by integrating the plurality of datasets into a feed provided to the data pipeline on a regular basis.

20. A non-transitory computer readable medium comprising computer-executable instructions for integrating selectable inputs with real-time data pipelines to execute actions, the computer readable medium being executed by a processor of a computer system comprising a data interface, comprising instructions for:
obtaining, via the data interface, at least one dataset comprising real-time data used to execute an action;
rendering, to a client device coupled to the system, a graphical user interface that presents the real-time data from the at least one dataset;
enabling selection of a datapoint on the real-time data from the graphical user interface;
displaying information associated with the action based on the selection;
enabling the selection to be confirmed as an input to execute the action;
providing, via the data interface, the input to a real-time data pipeline; and
executing a workflow comprising execution of the action using the input.
